(19) United States
(12) Patent Application Publication
(10) Pub. No.: US 2010/0138735 A1
(43) Pub. Date: Jun. 3, 2010

(54) DOCUMENT PROCESSING DEVICE

(75) Inventor: Naoya Uematsu, Tokushima-shi (JP)

Correspondence Address: SUGHRUE MION, PLLC, 2100 PENNSYLVANIA AVENUE, N.W., SUITE 800, WASHINGTON, DC, 20037, US

(73) Assignee: JUSTSYSTEMS CORPORATION, Tokushima-shi, Tokushima (JP)

(21) Appl. No.: 11/993,536

(22) PCT Filed: Jun. 26, 2006
(86) PCT No.: PCT/JP2006/312753

§ 371 Date: Dec. 21, 2007

(30) Foreign Application Priority Data
Jun. 24, 2005 (JP) 2005-185615
Sep. 16, 2005 (JP) 2005-271203

(51) Int. Cl. G06F 17/00

(52) U.S. Cl. 715/234

(57) ABSTRACT

A technique is provided which appropriately processes data structured by a markup language.

An acquisition unit acquires a document to be processed, a definition file associated with the document, a definition file which provides various kinds of tools for processing the document, etc. A launcher control unit displays the documents and tools thus acquired in the form of icons. Upon the user clicking the icon, the launcher control unit launches the document or tool that corresponds to the icon thus clicked. When a document is opened by a launcher according to an instruction from the launcher control unit, a layout control unit controls the layout of the display region for the document on a screen. When multiple documents are opened, a linkage control unit controls the linkage of data pieces among these documents. When the document includes data associated with time information, a time slider control unit displays a time slider which provides an interface function for allowing the user to set time information.

### TECHNICAL FIELD

The present invention relates to a document processing technique, and particularly to a document processing apparatus for processing a document described in a markup language.

### BACKGROUND ART

XML has been attracting attention as a format that allows the user to share data with other users via a network. This encourages the development of applications for creating, displaying, and editing XML documents (see Patent document 1, for example). The XML documents are created based upon a vocabulary (tag set) defined according to a document type definition.

### [Patent Document 1]

Japanese Patent Application Laid-open No. 2001-290804

### DISCLOSURE OF THE INVENTION

### Problem to be Solved by the Invention

The XML technique allows the user to define vocabularies as desired. In theory, this allows a limitless number of vocabularies to be created. It does not serve any practical purpose to provide dedicated viewer/editor environments for such a limitless number of vocabularies. Conventionally, when a user edits a document described in a vocabulary for which there is no dedicated editing environment, the user is required to directly edit the text-based source file of the document.

The present invention has been made in view of such a situation. Accordingly, it is a general purpose of the present invention to provide a technique which improves the convenience of processing data structured by a markup language.

### Means to Solve the Problem

In order to solve the aforementioned problem, a document processing apparatus according to an embodiment of the present invention comprises: an acquisition unit which acquires multiple documents; a linkage control unit which creates correspondence between data pieces included in the multiple documents, and controls the correspondence between the data pieces; and a display control unit which displays the multiple documents with the data pieces linked with each other according to the correspondence thus created.

Also, the linkage control unit may create the correspondence based upon the element names or the attribute names of the data pieces. Also, the display control unit may acquire a definition file which defines rules for displaying the data pieces linked with each other according to the correspondence thus created. With such an arrangement, the display control unit may display the multiple documents based upon the rules. Also, the document processing apparatus may further comprise a time slider control unit configured such that, in a case in which the document includes data associated with time information, a time slider is displayed, which allows the user to set the time information. Also, an arrangement may be made in which, in a case in which multiple documents that are being processed include data pieces associated with the time information, the data pieces are displayed synchronously with the time information received by the time slider control unit.

Another embodiment of the present invention also relates to a document processing apparatus. The document processing apparatus comprises: an acquisition unit which acquires a document described in a markup language; a processing system which processes data included in the document thus acquired; and a linkage control unit which selects the data, which is to be processed by the processing system, from the data included in the document. With such an arrangement, the linkage control unit acquires the information for selecting the data which can be processed by the processing system. Furthermore, the linkage control unit selects based upon the information thus acquired, the data, which is to be processed by the processing system, from the document thus acquired by the acquisition unit.

Also, the processing system may have the information for selecting the data which can be processed by the processing system. With such an arrangement, the linkage control unit may acquire the information from the processing system so as to select the data to be processed by the processing system. Also, the document may have additional information which defines the data included in the document in a semantic manner. With such an arrangement, the linkage control unit may select the data to be processed by the processing system with reference to the information that defines the data in a semantic manner. Also, the information for selecting the data which can be processed by the processing system may include the information which defines the data in a semantic manner. With such an arrangement, the linkage control unit may make a comparison between the information that defines in a semantic manner the data which can be processed by the processing system and the information which defines in a semantic manner the data included in the document so as to extract the data in which the information matching is satisfied in a conceptual manner. Also, the linkage control unit may calculate scores that indicate the semantic distances in increments of data pieces included in the document based upon the information that defines in a semantic manner the data which can be processed by the processing system and the information that defines in a semantic manner the data included in the document. With such an arrangement, the linkage control unit may select the data which is to be processed by the processing system with reference to the scores.

When the processing system processes multiple kinds of data pieces, the linkage control unit may extract the candidates of data pieces, which are to be processed by the processing system, from among the data pieces included in the document in increments of the multiple kinds of data pieces. With such an arrangement, the linkage control unit may select the data piece to be processed by the processing system from among the candidates thus extracted, based upon the degree of the structural vicinity in a hierarchical structure of the document.

Yet another embodiment of the present invention relates to a document processing method. The document processing method comprises: acquisition of a document described in a markup language; acquisition of information for selecting data which can be processed by a processing system which processes data described in the markup language; selection of data, which is to be processed by the processing system, from the document thus acquired based upon the information for selecting the data; and issuing an instruction to the processing system to process the data thus selected.

It should be noted that any combination of the aforementioned components or any manifestation of the present invention realized by modification of a method, apparatus, system, and so forth, is effective as an embodiment of the present invention.

### Advantage of the Present Invention

The present invention provides a technique for improving the convenience of processing data structured by a markup language.

### BRIEF DESCRIPTION OF THE DRAWINGS

FIG. 1 is a diagram which shows a configuration of a document processing apparatus according to the Background Art.

FIG. 2 is a diagram which shows an example of an XML document which is to be edited by the document processing apparatus.

FIG. 3 is a diagram which shows an example in which the XML document shown in FIG. 2 is mapped to a table described in HTML.

FIG. 4(a) is a diagram which shows an example of a definition file used for mapping the XML document shown in FIG. 2 to the table shown in FIG. 3.

FIG. 4(b) is a diagram which shows an example of a definition file used for mapping the XML document shown in FIG. 2 to the table shown in FIG. 3.

FIG. 5 is a diagram which shows an example of a screen on which the XML document shown in FIG. 2 is displayed after having been mapped to HTML according to the correspondence shown in FIG. 3.

FIG. 6 is a diagram which shows an example of a graphical user interface provided by a definition file creating unit, which allows the user to create a definition file.

FIG. 7 is a diagram which shows another example of a screen layout created by the definition file creating unit.

FIG. 8 is a diagram which shows an example of an editing screen for an XML document, as provided by the document processing apparatus.

FIG. 9 is a diagram which shows another example of an XML document which is to be edited by the document processing apparatus.

FIG. 10 is a diagram which shows an example of a screen on which the document shown in FIG. 9 is displayed.

FIG. 11 is a diagram which shows a configuration of a document processing apparatus according to an embodiment.

FIG. 12 is a diagram which shows an example of a display screen.

FIG. 13 is a diagram which shows an example of a display screen.

FIG. 14 is a diagram which shows an example of a display screen.

FIG. 15 is a diagram which shows an example of a display screen.

FIG. 16 is a diagram which shows an example of a display screen.

FIG. 17 is a diagram which shows an example of a display screen.

FIG. 18 is a diagram which shows an example of a display screen.

FIG. 19 is a diagram which shows an example of a display screen.

FIG. 20 is a diagram which shows an example of a display screen.

FIG. 21 is a diagram which shows an example of XML data defined in a semantic manner.

### DESCRIPTION OF THE REFERENCE NUMERALS

20 document processing apparatus, 22 main control unit, 24 editing unit, 30 DOM unit, 32 DOM provider, 34 DOM builder, 36 DOM writer, 40 CSS unit, 42 CSS parser, 44 CSS provider, 46 rendering unit, 50 HTML unit, 52, 62 control unit, 54, 64 editing unit, 56, 66 display unit, 60 SVG unit, 70 acquisition unit, 71 linkage control unit, 72 launcher control unit, 73 layout control unit, 74 time slider control unit, 80 VC unit, 82 mapping unit, 84 definition file acquisition unit, 86 definition file creating unit, 100 document processing apparatus

### BEST MODE FOR CARRYING OUT THE INVENTION

(Base Technology)

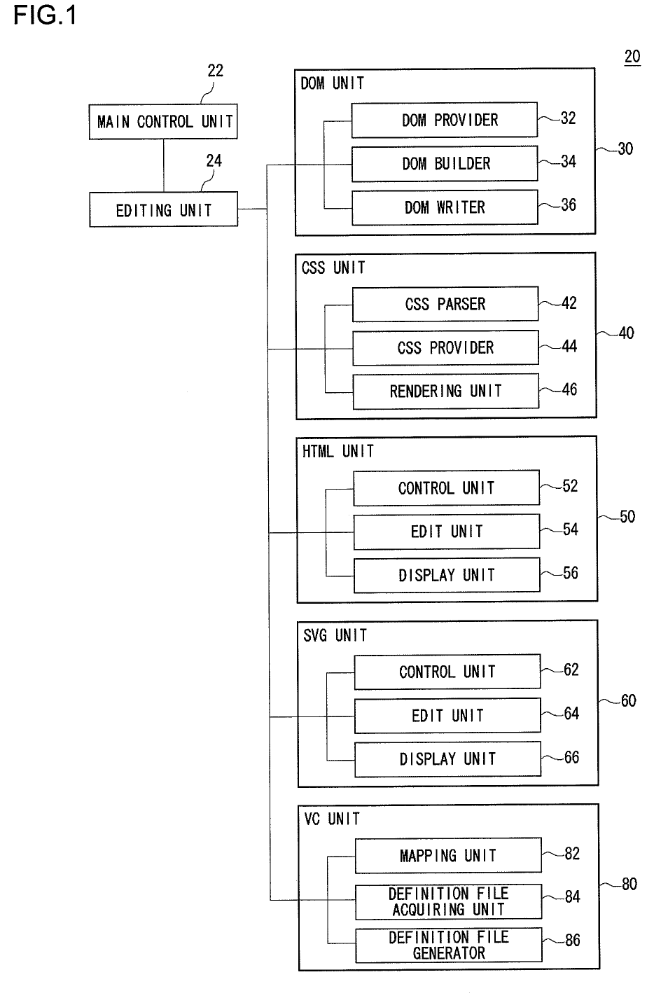

FIG. 1 illustrates a structure of a document processing apparatus 20 according to Base Technology. The document processing apparatus 20 processes a structured document where data in the document are classified into a plurality of components having a hierarchical structure. Represented in Base Technology is an example in which an XML document, as one type of a structured document, is processed. The document processing apparatus 20 is comprised of a main control unit 22, an editing unit 24, a DOM unit 30, a CSS unit 40, an HTML unit 50, an SVG unit 60 and a VC unit 80 which serves as an example of a conversion unit. In terms of hardware components, these unit structures may be realized by any conventional processing system or equipment, including a CPU or memory of any computer, a memory-loaded program, or the like. Here, the drawing shows a functional block configuration which is realized by cooperation between the hardware components and software components. Thus, it should be understood by a person skilled in the art that these functional blocks can be realized in a variety of forms by hardware only, software only or the combination thereof.

The main control unit 22 provides for the loading of a plug-in or a framework for executing a command. The editing unit 24 provides a framework for editing XML documents. Display and editing functions for a document in the document processing apparatus 20 are realized by plug-ins, and the necessary plug-ins are loaded by the main control unit 22 or the editing unit 24 according to the type of document under consideration. The main control unit 22 or the editing unit 24 determines which vocabulary or vocabularies describes the content of an XML document to be processed, by referring to a name space of the document to be processed, and loads a plug-in for display or editing corresponding to the thus determined vocabulary so as to execute the display or the editing. For instance, an HTML unit 50, which displays and edits HTML documents, and an SVG unit 60, which displays and edits SVG documents, are implemented in the document processing apparatus 20. That is, a display system and an editing system are implemented as plug-ins for each vocabulary (tag set), so that when an HTML document and an SVG document are edited, HTML unit 50 and the SVG unit 60 are loaded, respectively. As will be described later, when compound documents, which contain both HTML and SVG components, are to be processed, both HTML unit 50 and the SVG unit 60 are loaded.

By implementing the above structure, a user can select so as to install only necessary functions, and can add or delete a function or functions at a later stage, as appropriately. Thus, the storage area of a recording medium, such as a hard disk, can be effectively utilized, and the wasteful use of memory can be prevented at the time of executing programs. Furthermore, since the capability of this structure is highly expandable, a developer can deal with new vocabularies in the form of plug-ins, and thus the development process can be readily facilitated. As a result, the user can also add a function or functions easily at low cost by adding a plug-in or plug-ins.

The editing unit 24 receives an event, which is an editing instruction, from the user via the user interface. Upon reception of such an event, the editing unit 24 notifies a suitable plug-in or the like of this event, and controls the processing such as redoing this event, canceling (undoing) this event, etc.

The DOM unit 30 includes a DOM provider 32, a DOM builder 34 and a DOM writer 36. The DOM unit 30 realizes functions in compliance with a document object model (DOM), which is defined to provide an access method used for handling data in the form of an XML document. The DOM provider 32 is an implementation of a DOM that satisfies an interface defined by the editing unit 24. The DOM builder 34 creates DOM trees from XML documents. As will be described later, when an XML document to be processed is mapped to another vocabulary by the VC unit 80, a source tree, which corresponds to the XML document in a mapping source, and a destination tree, which corresponds to the XML document in a mapping destination, are created. At the end of editing, for example, the DOM writer 36 outputs a DOM tree as an XML document.

The CSS unit 40, which provides a display function conforming to CSS, includes a CSS parser 42, a CSS provider 44 and a rendering unit 46. The CSS parser 42 has a parsing function for analyzing the CSS syntax. The CSS provider 44 is an implementation of a CSS object and performs CSS cascade processing on the DOM tree. The rendering unit 46 is a CSS rendering engine and is used to display documents, described in a vocabulary such as HTML, which are laid out using CSS.

HTML unit 50 displays or edits documents described in HTML. The SVG unit 60 displays or edits documents described in SVG. These display/editing systems are realized in the form of plug-ins, and each system is comprised of a display unit (also designated herein as a “canvas”) 56 and 66, which displays documents, a control unit (also designated herein as an “editlet”) 52 and 62, which transmits and receives events containing editing commands, and an edit unit (also designated herein as a “zone”) 54 and 64, which edits the DOM according to the editing commands. Upon the control unit 52 or 62 receiving a DOM tree editing command from an external source, the edit unit 54 or 64 modifies the DOM tree and the display unit 56 or 66 updates the display. These units have a structure similar to the framework of the so-called MVC (Model-View-Controller). With such a structure, in general, the display units 56 and 66 correspond to “View”. On the other hand, the control units 52 and 62 correspond to “Controller”, and the edit units 54 and 64 and DOM instance corresponds to “Model”. The document processing apparatus 20 according to the Base Technology allows an XML document to be edited according to each given vocabulary, as well as providing a function of editing HTML document in the form of tree display. HTML unit 50 provides a user interface for editing an HTML document in a manner similar to a word processor, for example. On the other hand, the SVG unit 60 provides a user interface for editing an SVG document in a manner similar to an image drawing tool.

The VC unit 80 includes a mapping unit 82, a definition file acquiring unit 84 and a definition file generator 86. The VC unit 80 performs mapping of a document, which has been described in a particular vocabulary, to another given vocabulary, thereby providing a framework that allows a document to be displayed and edited by a display/editing plug-in corresponding to the vocabulary to which the document is mapped. In the Base Technology, this function is called a vocabulary connection (VC). In the VC unit 80, the definition file acquiring unit 84 acquires a script file in which the mapping definition is described. Here, the definition file specifies the correspondence (connection) between the Nodes for each Node. Furthermore, the definition file may specify whether or not editing of the element values or attribute values is permitted. Furthermore, the definition file may include operation expressions using the element values or attribute values for the Node. Detailed description will be made later regarding these functions. The mapping unit 82 instructs the DOM builder 34 to create a destination tree with reference to the script file acquired by the definition file acquiring unit 84. This manages the correspondence between the source tree and the destination tree. The definition file generator 86 offers a graphical user interface which allows the user to create a definition file.

The VC unit 80 monitors the connection between the source tree and the destination tree. Upon reception of an editing instruction from the user via a user interface provided by a plug-in that handles a display function, the VC unit 80 first modifies a relevant Node of the source tree. As a result, the DOM unit 30 issues a mutation event indicating that the source tree has been modified. Upon reception of the mutation event thus issued, the VC unit 80 modifies a Node of the destination tree corresponding to the modified Node, thereby updating the destination tree in a manner that synchronizes with the modification of the source tree. Upon reception of a mutation event that indicates that the destination tree has been modified, a plug-in having functions of displaying/editing the destination tree, e.g., HTML unit 50, updates a display with reference to the destination tree thus modified. Such a structure allows a document described in any vocabulary, even a minor vocabulary used in a minor user segment, to be converted into a document described in another major vocabulary. This enables such a document described in a minor vocabulary to be displayed, and provides an editing environment for such a document.

An operation in which the document processing apparatus 20 displays and/or edits documents will be described herein below. When the document processing apparatus 20 loads a document to be processed, the DOM builder 34 creates a DOM tree from the XML document. The main control unit 22 or the editing unit 24 determines which vocabulary describes the XML document by referring to a name space of the XML document to be processed. If the plug-in corresponding to the vocabulary is installed in the document processing apparatus 20, the plug-in is loaded so as to display/edit the document. If, on the other hand, the plug-in is not installed in the document processing apparatus 20, a check shall be made to see whether a mapping definition file exists or not. And if the definition file exits, the definition file acquiring unit 84 acquires the definition file and creates a destination tree according to the definition, so that the document is displayed/edited by the plug-in corresponding to the vocabulary which is to be used for mapping. If the document is a compound document containing a plurality of vocabularies, relevant portions of the document are displayed/edited by plug-ins corresponding to the respective vocabularies, as will be described later. If the definition file does not exist, a source or tree structure of a document is displayed and the editing is carried out on the display screen.

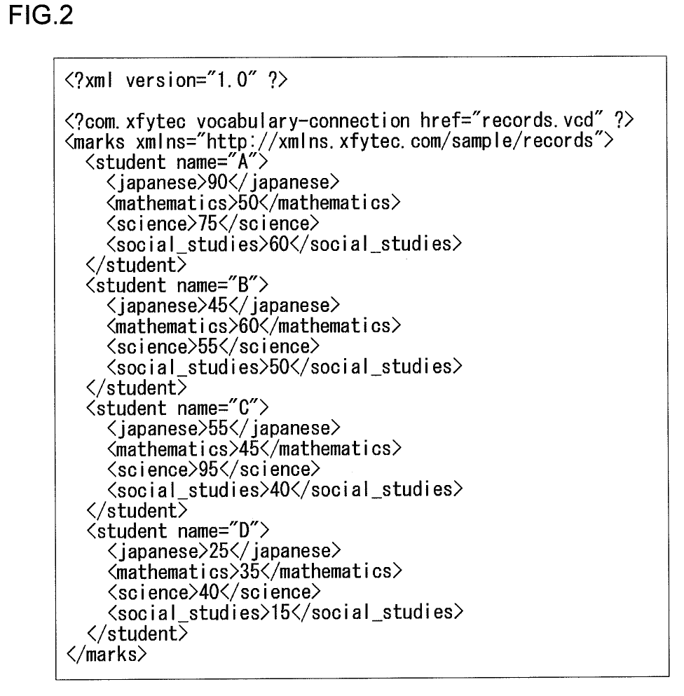

FIG. 2 shows an example of an XML document to be processed. According to this exemplary illustration, the XML document is used to manage data concerning grades or marks that students have earned. A component “marks”, which is the top Node of the XML document, includes a plurality of components “student” provided for each student under “marks”. The component “student” has an attribute “name” and contains, as child elements, the subjects “japanese”, “mathematics”, “science”, and “social studies”. The attribute “name” stores the name of a student. The components “japanese”, “mathematics”, “science” and “social studies” store the test scores for the subjects Japanese, mathematics, science, and social studies, respectively. For example, the marks of a student whose name is “A” are “90” for Japanese, “50” for mathematics, “75” for science and “60” for social studies. Hereinafter, the vocabulary (tag set) used in this document will be called “marks managing vocabulary”.

Here, the document processing apparatus 20 according to the Base Technology does not have a plug-in which conforms to or handles the display/editing of marks managing vocabularies. Accordingly, before displaying such a document in a manner other than the source display manner or the tree display manner, the above-described VC function is used. That is, there is a need to prepare a definition file for mapping the document, which has been described in the marks managing vocabulary, to another vocabulary, which is supported by a corresponding plug-in, e.g., HTML or SVG. Note that description will be made later regarding a user interface that allows the user to create the user's own definition file. Now, description will be made below regarding a case in which a definition file has already been prepared.

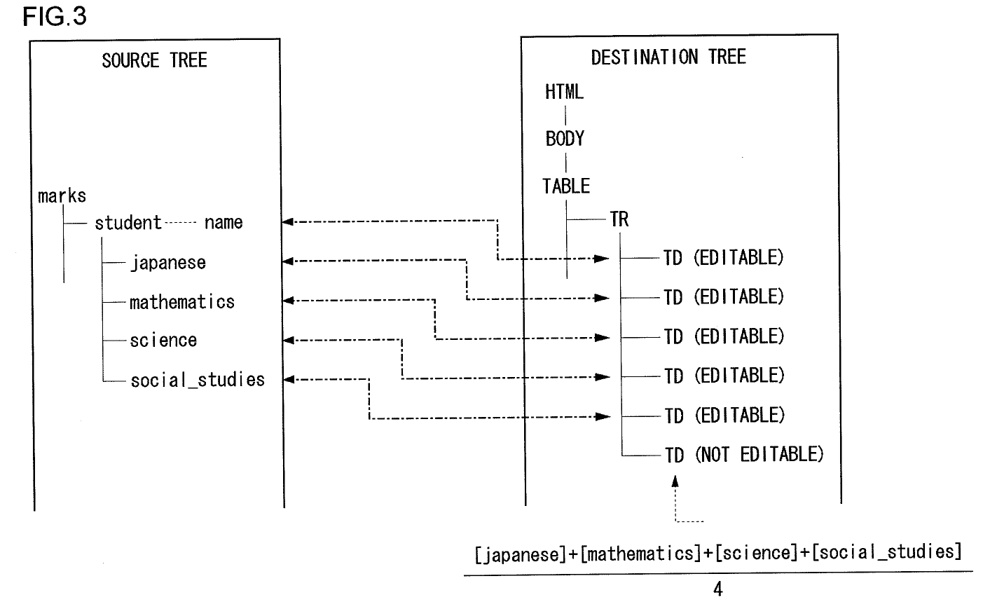

FIG. 3 shows an example in which the XML document shown in FIG. 2 is mapped to a table described in HTML. In an example shown in FIG. 3, a “student” Node in the marks managing vocabulary is associated with a row (“TR” Node) of a table (“TABLE” Node) in HTML. The first column in each row corresponds to an attribute value “name”, the second column to a “japanese” Node element value, the third column to a “mathematics” Node element value, the fourth column to a “science” Node element value and the fifth column to a “social studies” Node element value. As a result, the XML document shown in FIG. 2 can be displayed in an HTML tabular format. Furthermore, these attribute values and element values are designated as being editable, so that the user can edit these values on a display screen using an editing function of HTML unit 50. In the sixth column, an operation expression is designated for calculating a weighted average of the marks for Japanese, mathematics, science and social studies, and average values of the marks for each student are displayed. In this manner, more flexible display can be effected by making it possible to specify the operation expression in the definition file, thus improving the users' convenience at the time of editing. In this example shown in FIG. 3, editing is designated as not being possible in the sixth column, so that the average value alone cannot be edited individually. Thus, in the mapping definition it is possible to specify editing or no editing so as to protect the users against the possibility of performing erroneous operations.

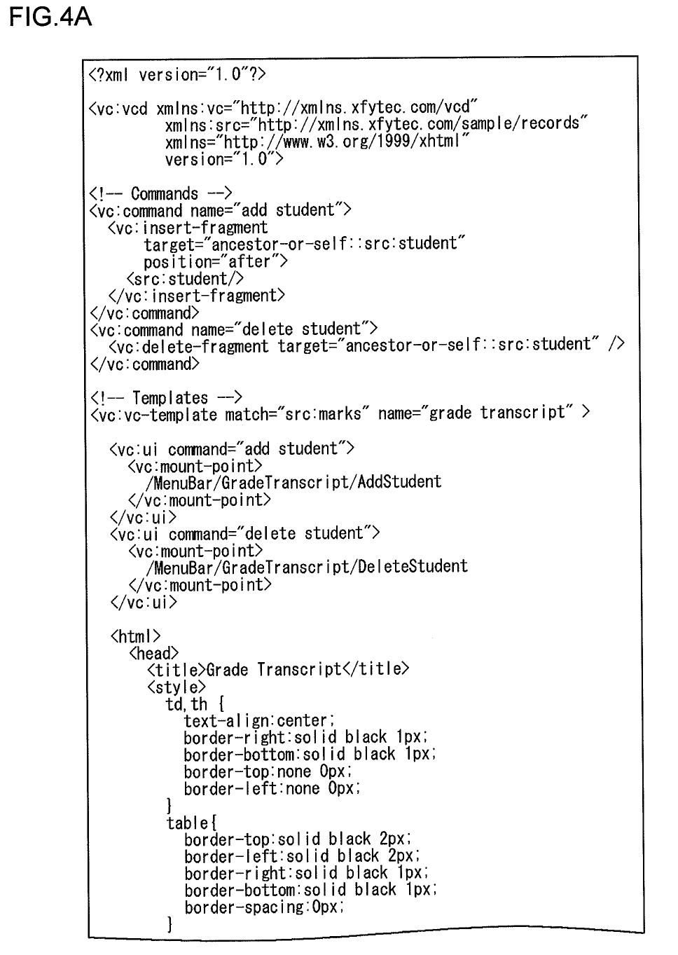

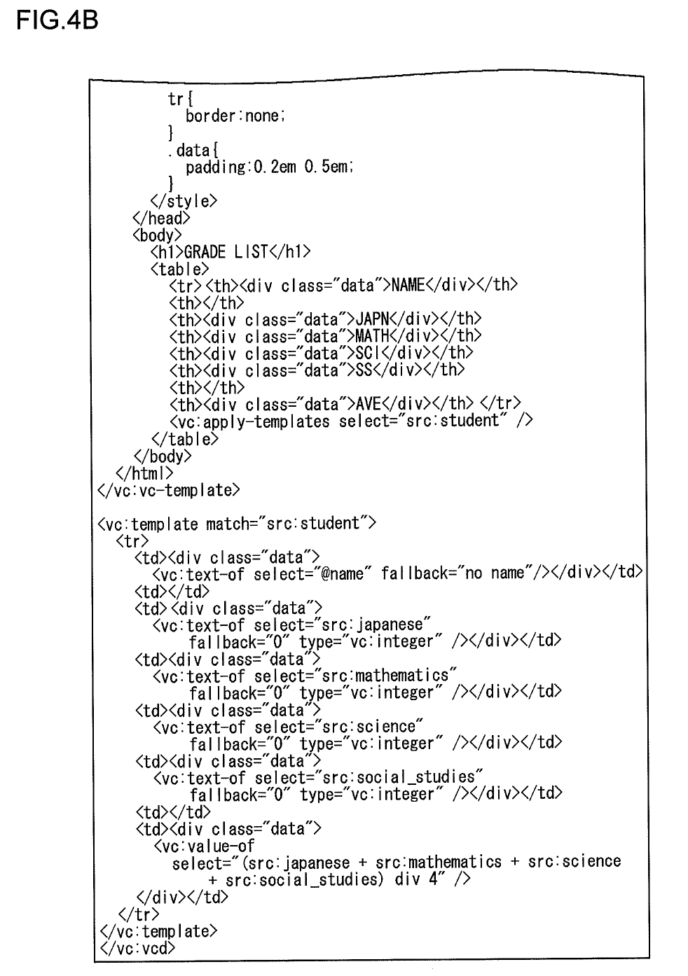

FIG. 4(a) and FIG. 4(b) illustrate an example of a definition file to map the XML document shown in FIG. 2 to the table shown in FIG. 3. This definition file is described in script language defined for use with definition files. In the definition file, definitions of commands and templates for display are described. In the example shown in FIG. 4(a) and FIG. 4(b), “add student” and “delete student” are defined as commands, and an operation of inserting a Node “student” into a source tree and an operation of deleting the Node “student” from the source tree, respectively, are associated with these commands. Furthermore, the definition file is described in the form of a template, which describes that a header, such as “name” and “japanese”, is displayed in the first row of a table and the contents of the Node “student” are displayed in the second and subsequent rows. In the template displaying the contents of the Node “student”, a term containing “text-of” indicates that editing is permitted, whereas a term containing “value-of” indicates that editing is not permitted. Among the rows where the contents of the

Node “student” are displayed, an operation expression “(src:japanese+src:mathematics+scr:science+scr:social_studies) div 4” is described in the sixth row. This means that the average of the student's marks is displayed.

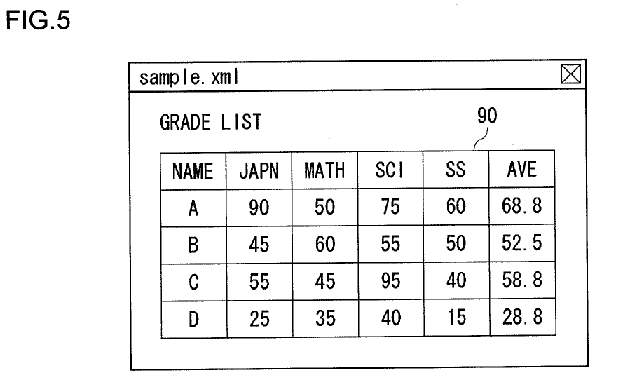

FIG. 5 shows an example of a display screen on which an XML document described in the marks managing vocabulary shown in FIG. 2 is displayed by mapping the XML document to HTML using the correspondence shown in FIG. 3. Displayed from left to right in each row of a table 90 are the names of each student, marks for Japanese, marks for mathematics, marks for science, marks for social studies and the averages thereof. The user can edit the XML document on this screen. For example, when the value in the second row and the third column is changed to “70”, the element value in the source tree corresponding to this Node, that is, the marks of student “B” for mathematics are changed to “70”. At this time, in order to have the destination tree follow the source tree, the VC unit 80 changes a relevant portion of the destination tree accordingly, so that HTML unit 50 updates the display based on the destination tree thus changed. Hence, the marks of student “B” for mathematics are changed to “70”, and the average is changed to “55” in the table on the screen.

On the screen as shown in FIG. 5, commands like “add student” and “delete student” are displayed in a menu as defined in the definition file shown in FIG. 4(a) and FIG. 4(b). When the user selects a command from among these commands, a Node “student” is added or deleted in the source tree. In this manner, with the document processing apparatus 20 according to the Base Technology, it is possible not only to edit the element values of components in a lower end of a hierarchical structure but also to edit the hierarchical structure. An edit function for editing such a tree structure may be presented to the user in the form of commands. Furthermore, a command to add or delete rows of a table may, for example, be linked to an operation of adding or deleting the Node “student”. A command to embed other vocabularies therein may be presented to the user. This table may be used as an input template, so that marks data for new students can be added in a fill-in-the-blank format. As described above, the VC function allows a document described in the marks managing vocabulary to be edited using the display/editing function of HTML unit 50.

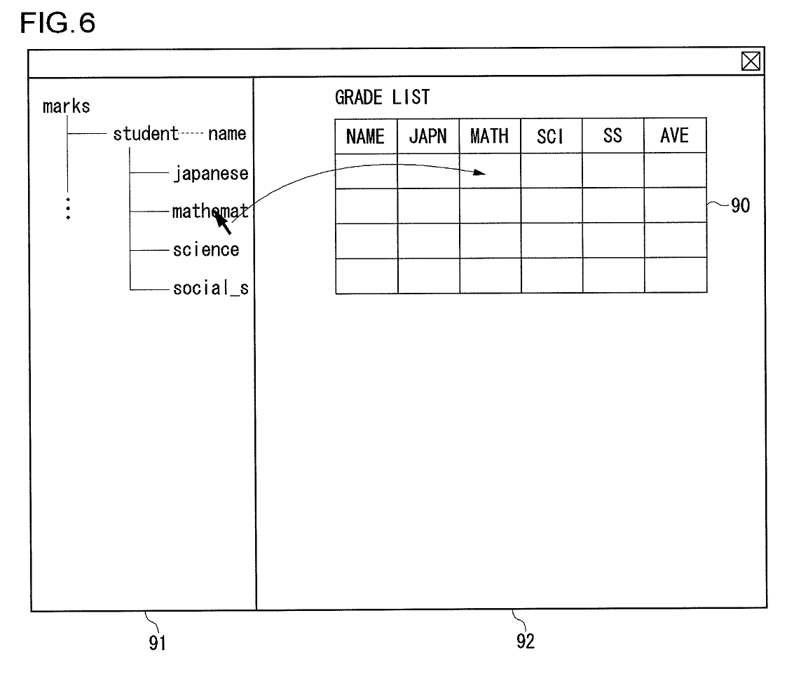

FIG. 6 shows an example of a graphical user interface, which the definition file generator 86 presents to the user, in command for the user to create a definition file. An XML document to be mapped is displayed in a tree in a left-hand area 91 of a screen. The screen layout of an XML document after mapping is displayed in a right-hand area 92 of the screen. This screen layout can be edited by HTML unit 50, and the user creates a screen layout for displaying documents in the right-hand area 92 of the screen. For example, a Node of the XML document which is to be mapped, which is displayed in the left-hand area 91 of the screen, is dragged and dropped into HTML screen layout in the right-hand area 92 of the screen using a pointing device such as a mouse, so that a connection between a Node at a mapping source and a Node at a mapping destination is specified. For example, when “mathematics,” which is a child element of the element “student,” is dropped to the intersection of the first row and the third column in a table 90 on HTML screen, a connection is established between the “mathematics” Node and a “TD” Node in the third column. Either editing or no editing can be specified for each Node. Moreover, the operation expression can be embedded in a display screen. When the screen editing is completed, the definition file generator 86 creates definition files, which describe connections between the screen layout and Nodes.

Viewers or editors which can handle major vocabularies such as XHTML, MathML and SVG have already been developed. However, it does not serve any practical purpose to develop dedicated viewers or editors for such documents described in the original vocabularies as shown in FIG. 2. If, however, the definition files for mapping to other vocabularies are created as mentioned above, the documents described in the original vocabularies can be displayed and/or edited utilizing the VC function without the need to develop a new viewer or editor.

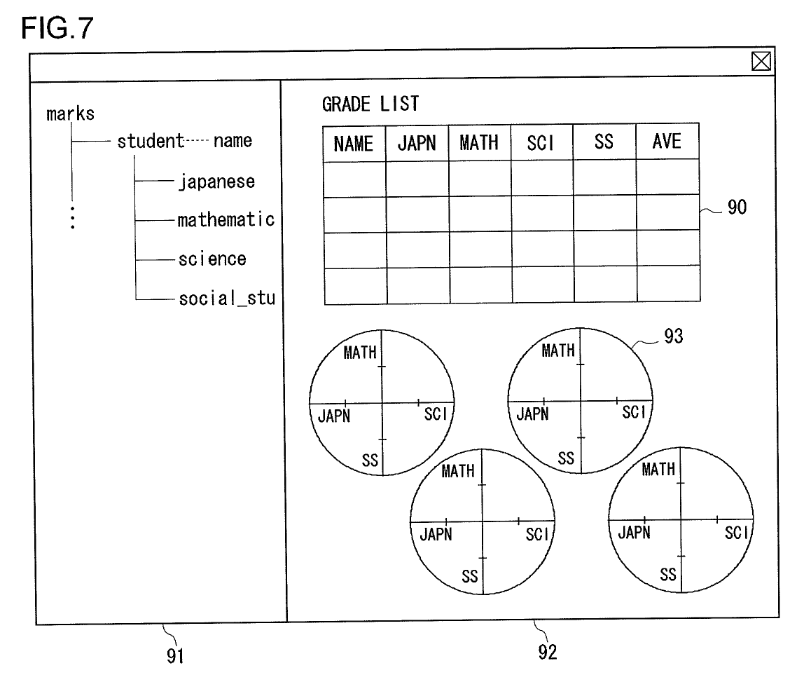

FIG. 7 shows another example of a screen layout created by the definition file generator 86. In the example shown in FIG. 7, a table 90 and circular graphs 93 are created on a screen for displaying XML documents described in the marks managing vocabulary. The circular graphs 93 are described in SVG. As will be discussed later, the document processing apparatus 20 according to the Base Technology can process a compound document described in the form of a single XML document according to a plurality of vocabularies. That is why the table 90 described in HTML and the circular graphs 93 described in SVG can be displayed on the same screen.

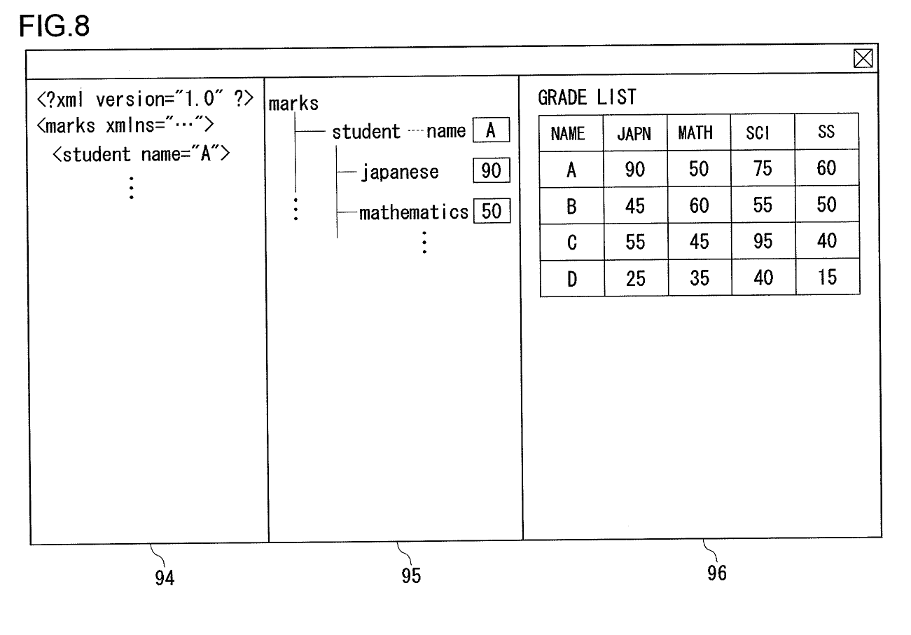

FIG. 8 shows an example of a display medium, which in a preferred but non-limiting embodiment is an edit screen, for XML documents processed by the document processing apparatus 20. In the example shown in FIG. 8, a single screen is partitioned into a plurality of areas and the XML document to be processed is displayed in a plurality of different display formats at the respective areas. The source of the document is displayed in an area 94, the tree structure of the document is displayed in an area 95, and the table shown in FIG. 5 and described in HTML is displayed in an area 96. The document can be edited in any of these areas, and when the user edits content in any of these areas, the source tree will be modified accordingly, and then each plug-in that handles the corresponding screen display updates the screen so as to effect the modification of the source tree. Specifically, display units of the plug-ins in charge of displaying the respective edit screens are registered in advance as listeners for mutation events that provide notice of a change in the source tree. When the source tree is modified by any of the plug-ins or the VC unit 80, all the display units, which are displaying the edit screen, receive the issued mutation event(s) and then update the screens. At this time, if the plug-in is executing the display through the VC function, the VC unit 80 modifies the destination tree following the modification of the source tree. Thereafter, the display unit of the plug-in modifies the screen by referring to the destination tree thus modified.

For example, when the source display and tree-view display are implemented by dedicated plug-ins, the source-display plug-in and the tree-display plug-in execute their respective displays by directly referring to the source tree without involving the destination tree. In this case, when the editing is done in any area of the screen, the source-display plug-in and the tree-display plug-in update the screen by referring to the modified source tree. Also, HTML unit 50 in charge of displaying the area 96 updates the screen by referring to the destination tree, which has been modified following the modification of the source tree.

The source display and the tree-view display can also be realized by utilizing the VC function. That is to say, an arrangement may be made in which the source and the tree structure are laid out in HTML, an XML document is mapped to HTML structure thus laid out, and HTML unit 50 displays the XML document thus mapped. In such an arrangement, three destination trees in the source format, the tree format and the table format are created. If the editing is carried out in any of the three areas on the screen, the VC unit 80 modifies the source tree and, thereafter, modifies the three destination trees in the source format, the tree format and the table format. Then, HTML unit 50 updates the three areas of the screen by referring to the three destination trees.

In this manner, a document is displayed on a single screen in a plurality of display formats, thus improving a user's convenience. For example, the user can display and edit a document in a visually easy-to-understand format using the table 90 or the like while understanding the hierarchical structure of the document by the source display or the tree display. In the above example, a single screen is partitioned into a plurality of display formats, and they are displayed simultaneously. Also, a single display format may be displayed on a single screen so that the display format can be switched according to the user's instructions. In this case, the main control unit 22 receives from the user a request for switching the display format and then instructs the respective plug-ins to switch the display.

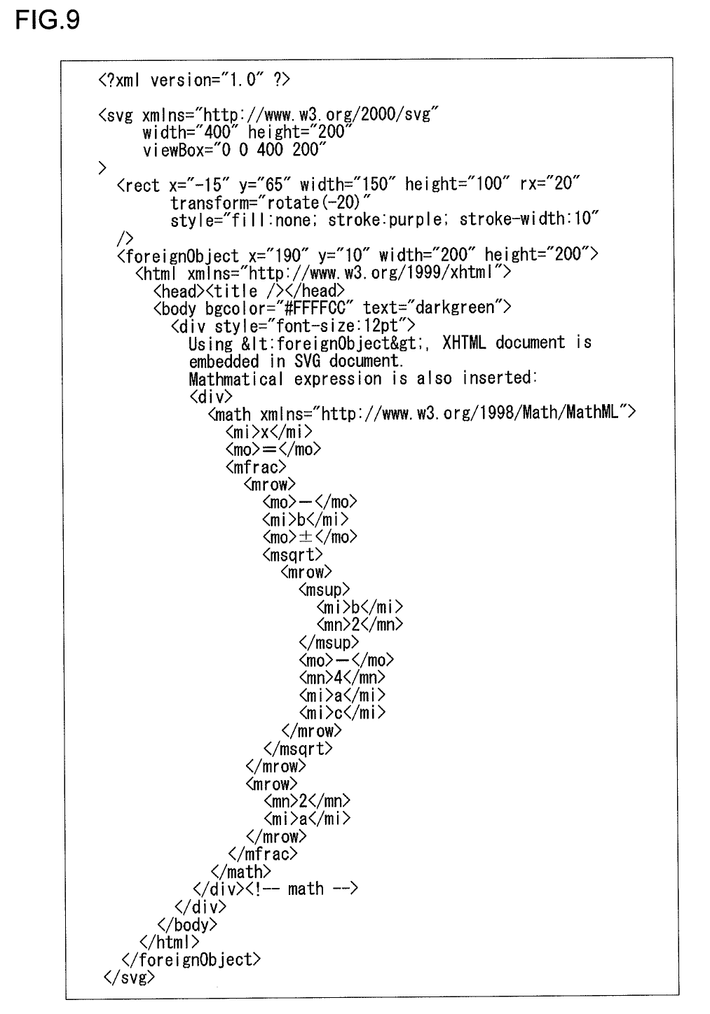

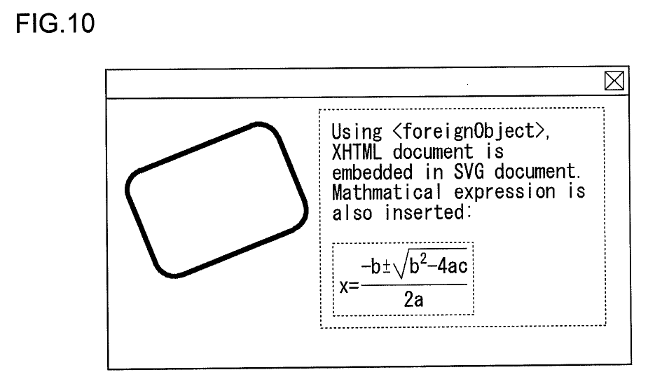

FIG. 9 illustrates another example of an XML document edited by the document processing apparatus 20. In the XML document shown in FIG. 9, an XHTML document is embedded in a “foreignObject” tag of an SVG document, and the XHTML document contains an equation described in MathML. In this case, the editing unit 24 assigns the rendering job to an appropriate display system by referring to the name space. In the example illustrated in FIG. 9, first, the editing unit 24 instructs the SVG unit 60 to render a rectangle, and then instructs HTML unit 50 to render the XHTML document. Furthermore, the editing unit 24 instructs a MathML unit (not shown) to render an equation. In this manner, the compound document containing a plurality of vocabularies is appropriately displayed. FIG. 10 illustrates the resulting display.

The displayed menu may be switched corresponding to the position of the cursor (carriage) during the editing of a document. That is, when the cursor lies in an area where an SVG document is displayed, the menu provided by the SVG unit 60, or a command set which is defined in the definition file for mapping the SVG document, is displayed. On the other hand, when the cursor lies in an area where the XHTML document is displayed, the menu provided by HTML unit 50, or a command set which is defined in the definition file for mapping HTML document, is displayed. Thus, an appropriate user interface can be presented according to the editing position.

In a case that there is neither a plug-in nor a mapping definition file suitable for any one of the vocabularies according to which the compound document has been described, a portion described in this vocabulary may be displayed in source or in tree format. In the conventional practice, when a compound document is to be opened where another document is embedded in a particular document, their contents cannot be displayed without the installation of an application to display the embedded document. According to the Base Technology, however, the XML documents, which are composed of text data, may be displayed in source or in tree format so that the contents of the documents can be ascertained. This is a characteristic of the text-based XML documents or the like.

Another advantageous aspect of the data being described in a text-based language, for example, is that, in a single compound document, a part of the compound document described in a given vocabulary can be used as reference data for another part of the same compound document described in a different vocabulary. Furthermore, when a search is made within the document, a string of characters embedded in a drawing, such as SVG, may also be search candidates.

In a document described in a particular vocabulary, tags belonging to other vocabularies may be used. Though such an XML document is generally not valid, it can be processed as a valid XML document as long as it is well-formed. In such a case, the tags thus inserted that belong to other vocabularies may be mapped using a definition file. For instance, tags such as “Important” and “Most Important” may be used so as to display a portion surrounding these tags in an emphasized manner, or may be sorted out in the command of importance.

When the user edits a document on an edit screen as shown in FIG. 10, a plug-in or a VC unit 80, which is in charge of processing the edited portion, modifies the source tree. A listener for mutation events can be registered for each Node in the source tree. Normally, a display unit of the plug-in or the VC unit 80 conforming to a vocabulary that belongs to each Node is registered as the listener. When the source tree is modified, the DOM provider 32 traces toward a higher hierarchy from the modified Node. If there is a registered listener, the DOM provider 32 issues a mutation event to the listener. For example, referring to the document shown in FIG. 9, if a Node which lies lower than the <html> Node is modified, the mutation event is notified to HTML unit 50, which is registered as a listener to the <html> Node. At the same time, the mutation event is also notified to the SVG unit 60, which is registered as a listener in an <svg> Node, which lies upper to the <html> Node. At this time, HTML unit 50 updates the display by referring to the modified source tree. Since the Nodes belonging to the vocabulary of the SVG unit 60 itself are not modified, the SVG unit 60 may disregard the mutation event.

Depending on the contents of the editing, modification of the display by HTML unit 50 may change the overall layout. In such a case, the layout is updated by a screen layout management mechanism, e.g., the plug-in that handles the display of the highest Node, in increments of display regions which are displayed according to the respective plug-ins. For example, in a case of expanding a display region managed by HTML unit 50, first, HTML unit 50 renders a part managed by HTML unit 50 itself, and determines the size of the display region. Then, the size of the display area is notified to the component that manages the screen layout so as to request the updating of the layout. Upon receipt of this notice, the component that manages the screen layout rebuilds the layout of the display area for each plug-in. Accordingly, the display of the edited portion is appropriately updated and the overall screen layout is updated.

### Embodiment

The embodiment proposes a technique for data linkage among documents or processing systems for processing the documents in an arrangement which processes multiple document.

An arrangement which is capable of linking various data pieces or data processing functions adapted by XML allows the user to perform various kinds of information analysis in an on-demand and intuitive manner. Before description of this mechanism, there is a need to make description regarding the following two mechanisms roughly classified.

The first mechanism relates to a method for adapting the information, and a method for linking the information thus adapted. The first mechanism will be referred to as “XML data adaptation mechanism”. Description will be made in the embodiment regarding a method for adapting XML data to be handled, and a method for defining the linkage of the multiple data pieces thus adapted. With such an arrangement in which multiple data pieces or functions are linked with each other, each information piece constitutes of multiple elements. Accordingly, there is a need to specify how the elements included in each data piece or each function are linked with each other in increments of elements. The present embodiment provides an improved method which allows the user to link such elements with each other in an intuitive and simple manner.

The second mechanism relates to a user interface mechanism which allows the user to operate the above-described mechanism in an intuitive manner. The data should be linked with a function involving screen display such as data graphing function, which facilitating the understanding of the content of the data. Also, in other cases, the data should be linked to various data filters in order to arrange the information. The present embodiment proposes a UI which allows the user to operate the data and functions (display function, filter function, etc.) in an intuitive manner, thereby mining the information.

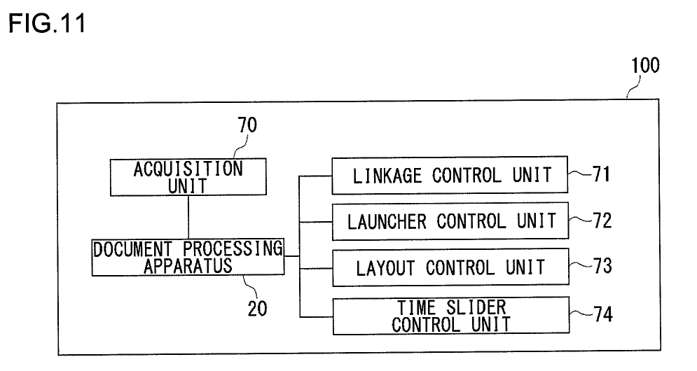

FIG. 11 shows a configuration of a document processing apparatus according to the present embodiment. A document processing apparatus 100 according to the present embodiment further includes an acquisition unit 70, a linkage control unit 71, a launcher control unit 72, a layout control unit 73, and a time slider control unit 74 in addition to the configuration of the document processing apparatus 20 described in the base technology shown in FIG. 1.

The acquisition unit 70 acquires a document to be processed, a definition file associated with the document, definition file which provides various kinds of tools for processing the document, etc. The launcher control unit 72 displays the documents and tools thus acquired in the form of icons. Upon the user clicking the icon, or performing a drag-and-drop operation, the launcher control unit 72 launches the corresponding document or tool. When the document is opened via a launcher provided by the launcher control unit 72, the layout control unit 73 controls the layout of the display region for the document on the screen. When multiple documents are opened, the linkage control unit 71 controls the data linkage among these documents. In a case in which the document includes data associated with time information, the time slider control unit 74 displays a time slider which provides a interface function for allowing the user to input time information.

Among these components, the linkage control unit 71 provides the aforementioned XML data adaptation mechanism. On the other hand, the launcher control unit 72, the layout control unit 73, and the time slider control unit 74 provide the aforementioned user interface mechanism.

First, description will be made regarding the XML data adaptation mechanism realized by the linkage control unit 71. This XML data adaptation mechanism provides the adaptation of data on the following assumption.

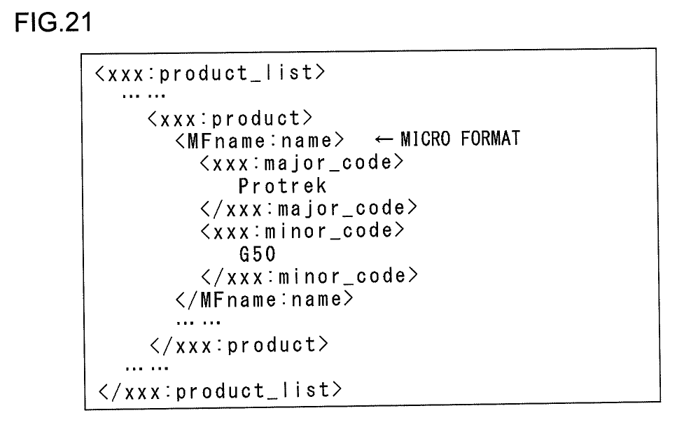

(1) The adaptation of the information is performed by adding an XML tag, which provides a particular meaning, to the information. That is to say, the adaptation of the information is restricted to the tag labeling which can be performed in a mechanical manner. Let us say that the XML tag name used here is represented by the most appropriate and the simplest term for facilitating the user's understanding. In the example shown in FIG. 21, the <MFname;name>, which is an XML tag, is provided, which facilitates the user's understanding in an intuitive manner that given information is defined as the information associated with “name”.

2) There are a great number of relatively small-scale adaptation formats customized for special purposes. Examples of such adaptation formats include: adaptation format for representing address information; adaptation format for representing commodity information; adaptation format for representing weather information; adaptation format for representing event information; etc., which are so-called micro formats. These micro formats are preferably provided in as the general formats as possible, thereby allowing the user to employ the micro formats for representing various kinds of information in common. With such an arrangement, the meaning of the overall information can be represented by a combination of the micro formats.

3) The relationship between these micro formats is defined under the upper-level ontology that provides further abstract concept thereof. Furthermore, before defining a new tag for a particular purpose, the relationship should be defined under the ontology. For example, let us consider an arrangement in which the term such as “price including sales tax” etc., is defined as a sub-class of a general term “money amount”. Such an arrangement resolves the ambiguity of the information, e.g., the ambiguity of whether the “money amount” matches the price with or without sales tax included, thereby enabling processing to be performed in an accurate manner.

(4) In some cases, a combination of the aforementioned micro formats has a nested structure as shown in an example in FIG. 21. Aside from the problem whether or not such a structure can be defined in the form of an XML structure, let us say that the document processing apparatus 20 is capable of processing such a nested structure.

With such an arrangement, an interface expression is prepared for each function, which indicates the kind of data which can be processed by the function. The interface expression is provided in the form of a list of tags which can be handled by the function. In a case in which the tag that represents the data to be linked matches a tag which can be handled by the processing function, the XML data adaptation mechanism links the data with the processing function.

The important operation in the data adaptation is the axis matching. For example, let us consider an arrangement having a function of displaying a two-dimensional scatter diagram. Such a function requires a data structure in the form of (X-axis value, Y-axis value, (auxiliary value)). Furthermore, there is a need to identify the correspondence between the elements in this data structure and the elements in given data. For example, the correspondence is identified according to the following procedure.

First, a check is made whether or not the data includes tags which can be handled as elements that correspond to respective axes. For example, in an example of displaying a two-dimensional scatter diagram, numerical value data pieces are associated with the X axis and the Y axis. Accordingly, check is made whether or not the data includes tags (elements) having an element value of a numerical value. In a step in which the data is associated with a function via the interface expression provided for each function, the interface expression may be configured to allow the user to associate the data with the function in increments of data blocks. Such an arrangement allows the user to clearly specify the target data.

Next, assuming a combination of the axes to be employed, the data is searched for a data structure in which the minimum sub-trees, each of which constitutes the combination of the axes to be obtained, are arrayed. For example, the positions of three XML data pieces on a tree structure associated with the triaxial value set, i.e., the X-axis value, the Y-axis value, and the auxiliary value, are located in the vicinity of each other at a high probability. Accordingly, the sub-tree with the minimum size is extracted as the combination with the most likelihood.

Last, the data is associated with the function based upon the axis combination thus obtained. Here, the most appropriate element is selected based upon the ontology-based semantic definition. Specifically, the score is calculated based upon the ontology distance (semantic path distance) between the target element and the data item. The correspondence that exhibits the highest sum total of the scores for the respective axes is assumed to be the most appropriate correspondence. In this step, if both the X-axis element and the Y-axis element are provided in the same format, there is a need to select the respective correspondences. Furthermore, in some cases, there is a need to resolve the ambiguity. Example of such cases include: a case in which there are multiple tag types in the sub-tree which can be associated with the function; a case in which another kind of sub-tree, which does not exhibit the minimum size, can be employed. In some cases, an inappropriate correspondence can be obtained based upon the ontology. Accordingly, such an arrangement may allows the user to switch the correspondence via the interface expression.

The interface expression provides a list of tags which can be handled. In some cases, the strict matching is required for handling the tag. In other cases, the tag can be handled when the rough matching is satisfied. The present embodiment allows the user to specify the required matching level. For example, in a case of setting the strict matching level, the unit and the meaning, e.g., the money amount, the number of people, etc., are strictly specified. In a case of setting the rough matching level, a desired value can be handled as long as the value is a numerical value, for example. The function that exhibits the high degree of freedom will be referred to as “adaptive function”. Data classification is made based upon the adaptive degree of respective tags according to the ontology that provides the semantic definition to each tag. In a case in which a given tag is ambiguous in the correspondence or the definition obtained based upon the ontology, such an arrangement searches for the position that corresponds to this target tag name based upon the upper-level (or domain) ontology provided by the data adaptation mechanism, and the position thus detected is associated with the data item, thereby associating the tag with the data item based upon the analysis results obtained according to the ontology. It is considered that, in a case in which there are a sufficient number of words which can be processed according to the ontology, and in a case in which each tag embedded in the data provides a common-sense and appropriate general concept, such an arrangement is capable of associating each tag with an appropriate data item with higher precision.

In a case in which the data type of the tag data or the physical representation of the information is defined for the tag which can be handled by each function, other information specified in this tag can be ignored. For example, let us consider a case in which the <name> tag which can be handled by a function is processed as a character string, and the data has a tag structure of <name><first>Ryouma</first><Family>Sakamoto</Family></name>. In this case, the character string “RyoumaSakamoto” is received as the data of the <name> tag, and the other tags are ignored.

Various methods are conceivable for the data linkage. In practice, such a method requires a processing program. In this mechanism, let us say that, instead of directly linking the data pieces with each other, the data pieces are linked with each other with a predetermined function introduced therebetween, thereby creating a linked data set such as “data A→function←data B”. Such an arrangement defines various kinds of processing provided among the data pieces by the functions such as “JOIN”, “OR”, “narrowing down”, etc.

Furthermore, each of the functions has a data input function and a data output function. The output of one function is used as the input of a different function. Before the data is input to the function, the data classification is made according to the interface expression and the ontology, thereby extracting from the data only the necessary portion for the processing of the function. Each function outputs the processing result in a predetermined format defined by the function.

The basic operation mechanism of the present system is defined in a data flow format. This system can be defined in the same way as in the ordinary data flow programming, which can define flow circulation, flow branching, etc., without any particular problem.

Next, description will be made regarding a UI mechanism realized by the launcher control unit 72, the layout control unit 73, the time slider control unit 74, etc. Description will be made below regarding a UI which performs data processing (data mining) in an intuitive manner using the above-described data adaptation mechanism.

The data mining UI can be classified into the following two types of views, for example. One is an interactive operation view which allows the user to operate data and function components in an intuitive manner by performing a drag-and-drop operation etc. The interactive operation view is constituted of a data processing stage which allows the user to make a combination of data pieces in an interactive manner, and a list of components which can be combined via the data processing stage. The other one is a programming view which allows the user to specify a more detailed or complicated operation. The programming view is effective for specifying analysis processing in a batch processing manner. Further detailed description will be made below regarding the interactive operation view.

The components handled via the data mining UI are listed below.

### 1) Data

The data used here means data such as a document, defined in XML in a semantic manner. Upon dropping the data on the data processing stage, the data is displayed on a screen in a basic manner. If editing is permitted, such an arrangement allows the user to edit the data.

### 2) Data Visualizing Function

The data visualizing function is a function for converting data into a visual image such as a graph, map, or the like. The data processing stage serves as a window which displays the data. Also, such a function may allow the user to edit the data.

### 3) Data Processing/Conversion Function

The data processing/conversion function is a function for converting the format of the data into a different format by performing computation or the like. Also, such a function may narrow down the data. The positioning of the data processing/conversion function in the data processing stage is like that of the overlay sheets with respect to the data visualizing function.

### 4) Trigger Function

The trigger function is a function which allows the user to perform auxiliary parameter operation for each function component. Typical conceivable examples include an arrangement which sequentially focuses iterating data pieces in an animation manner.

### 5) External Interface Function

The external interface function is a function which allows the user to link the data with an external database, a Web service, etc. Basically, the external data thus linked is handled via the UI in the same way as with the data.

### 6) Flow Control Function

The flow control function is used in the programming view.

Each of the function components listed here may allow the user to set the parameters every time the user uses the function. Also, an arrangement may be made in which, “instance components”, in each of which the parameters with a use frequency of a predetermined value or more have been set beforehand, are listed, which allows the user to select one from among the instance components thus listed according to the usage.

The linkage operation on the data processing stage for linking data with a function is performed according to the following procedure.

1) Such an arrangement allows the user to drop the component such as data on the data processing stage. On the data processing stage, the current component is focused.

2) When a function component is focused, the components in the component list are narrowed down into the data pieces which can be processed by the function component thus focused, and the function components which can be combined with the component thus focused (Also, the components which cannot be used may be grayed out). In a case in which the component is data, and the content of the data is displayed, the available portion or the unavailable portion is preferably displayed in a highlighted manner so as to allow the user to discriminate between the available portion and the unavailable portion. On the other hand, when a data component is focused, the components in the component list are narrowed down into the function components which can handle the data thus focused. When no component is focused, all the components are available. In this stage, only the components in the component list can be grayed out. On the other hand, all the components on the data processing stage are available. Such an arrangement allows the user to manually employ the components even if the correspondence between the components is not automatically identified.

3) Upon dropping data on a function component, the data is processed by the function component, and is displayed on the function component. Upon dropping a function component on data, the data display region is replaced by the display region for the function component, thereby displaying the content of the data thus processed by the function. In some cases, the data display is completely replaced by the display of the function component in the data processing stage. Also, in some cases, only the display of a part of the data thus processed is replaced by the display of the function component. Also, examples of the operation performed according to the user's dropping a function component on data include an operation for incorporating an image into a document.

4) In a case in which the user sequentially drops multiple data pieces on a function component, the data display and the processing operation are performed by the function component. Conceivable examples of the processing operation include: a processing operation in which the data pieces thus sequentially dropped are overlaid as separate data pieces; a processing operation in which the data pieces thus sequentially dropped are merged into a single large data piece.

5) With such an arrangement, an indicator that indicates a combination of the functions and data pieces is displayed in the form of tags or the like located at the corner of the region for displaying the components. Such an arrangement allows the user to change the processing order or the like by changing the tag order.

6) Upon applying an overlay-type component to a function component, the display position of the data is determined in cooperation with the function component. Basically, the display position of the overlay-type component is determined according to the display position setting made by the function component thus overlaid. Examples of the operations for displaying the data in a display format after the overlaying operation include: a) an operation in which the data pieces are narrowed down, and the data pieces thus narrowed down are newly input to the function component (pre-type); b) an operation in which all the data display of the function component is cleared, and the display is performed according to the settings of the overlay-type component (wrapper-type; c) an operation in which new display items are added to the display provided by the function component (post-type); and d) an operation in which the display is switched by modifying the parameters of the function component (trigger-type). The method is selected according to the tags thus stacked or the definition of the function component thus overlaid.

The above-described data adaptation mechanism searches for one-to-one name correspondence based upon the ontology, thereby automatically obtaining the correspondence between the data elements. However, in a case in which undesirable correspondence is automatically obtained in a certain selection range, such an arrangement may allow the user to change the correspondence by performing the following operation. With such an arrangement, the user can select the correspondence with reference to the conceptual distance or the vertical relation based upon the ontology. Thus, such an arrangement allows the user to select the correspondence from among the list of the correspondences arranged with probability information based upon the ontology, unlike an arrangement which allows the user to select the correspondence from among the correspondence list arranged without giving consideration to the ontology.

1) Upon performing a predetermined operation, e.g., upon right-clicking the tag of a function component having the settings to be modified, a menu is opened, which allows the user to modify the correspondence.

2) The candidates of the axes and values for the function component are listed on the left side. On the other hand, the candidates of the structures which can be associated with the candidates of the axes and values are listed on the right side. Such an arrangement allows the user to switch the correspondence by selecting the candidates.

3) In some cases, the user feels that the candidate list without information is insufficient for selecting the correspondence. In this case, upon the user selecting the nearest candidate of the element to be modified by performing clicking operation or the like, such an arrangement displays the tag tree of the data around the target structure, which allows the user to select the tag to be specified.

4) The selection thus made is stored along with the schema information with respect to the components or the data. The correspondence thus stored is employed at the highest priority in the following operations.

Subsequently, description will be made regarding the linkage of the components such as data pieces, functions, etc., made via the aforementioned data mining UI.

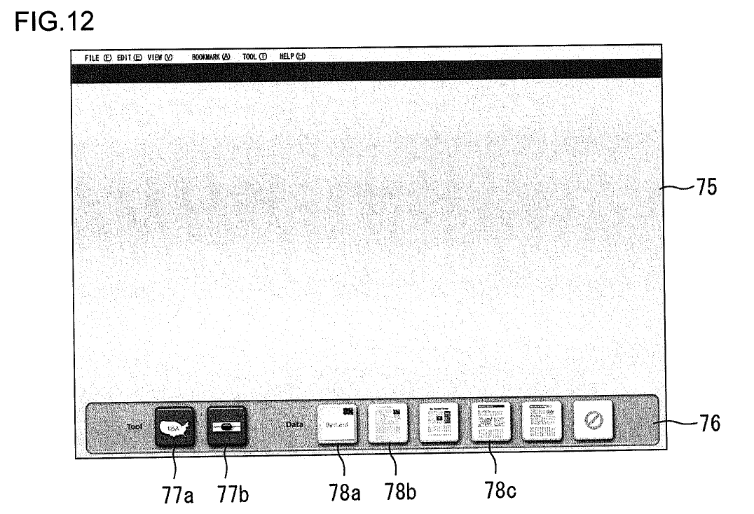

FIG. 12 shows an example of a display screen. The screen displays a data operation sheet 75 like a desktop, and a component palette 76 having various components arranged therein. The component palette 76 provided by the launcher control unit 72 includes: a blank-map tool icon 77a which provides a function of inserting a blank map of the USA; a time-slider tool icon 77b which provides a time slider interface having a function of allowing the user to operate the time parameters; and multiple icons 78 each of which represents a document.

Each icon 78 that represents a document may be displayed in the form of a reduced view of the actual document processed by a processing system such as the HTML unit 50 or the like. Such an arrangement may allow the user to edit the document on the icon 78.

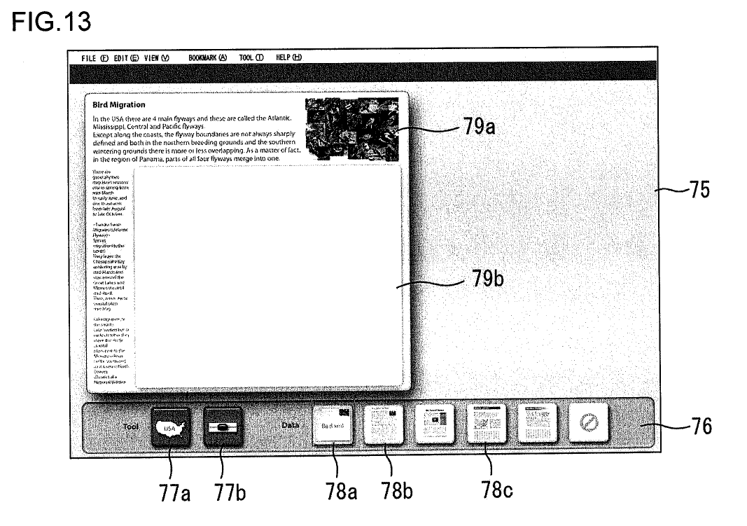

First, upon the user moving the icon that represents the document 78a to the data operation sheet 75 by a drag-and-drop operation, the display screen enters the state as shown in FIG. 13. The linkage control unit 71 detects that the document data has been dropped on the data operation sheet 75, and instructs the layout control unit 73 to allocate the display region for the document 78a. Furthermore, the linkage control unit 71 starts up a processing system which displays the document 78a, thereby displaying the document 78a. Then, the display region 79a is allocated for the document 78a by the layout control unit 73, and the document 78a is displayed in the display region 79a by an appropriate processing system.

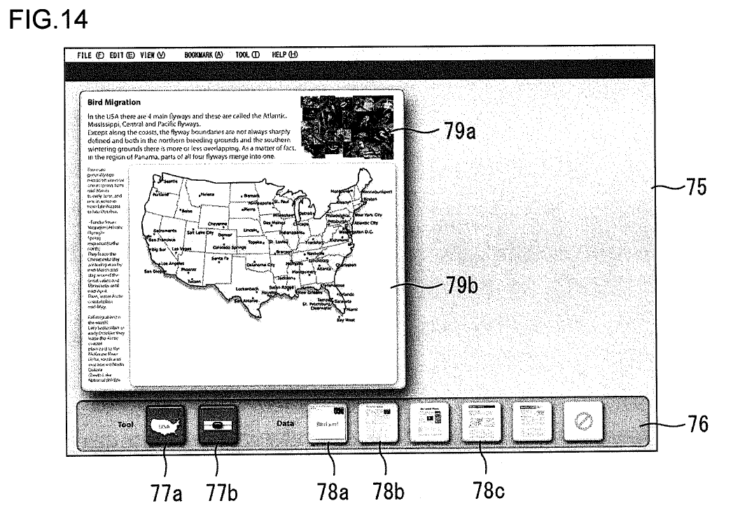

Subsequently, upon the user moving the icon 77a that provides the blank map tool to an empty display region 79b in the display region 79a of the document 78a by performing a drag-and-drop operation, the screen display enters the state shown in FIG. 14. The linkage control unit 71 detects that the blank map display function has been dropped on the empty display region 79b, and instructs an appropriate processing system to display a blank map in the empty region. For example, the layout control unit 73 inserts the blank map in the empty display region 79b. The document that stores the blank map data may be inserted into the document 78a. Also, the document that stores the blank map data may be referred to by the document 78a. The blank map is described in SVG, for example, and may be displayed by the SVG unit 60.

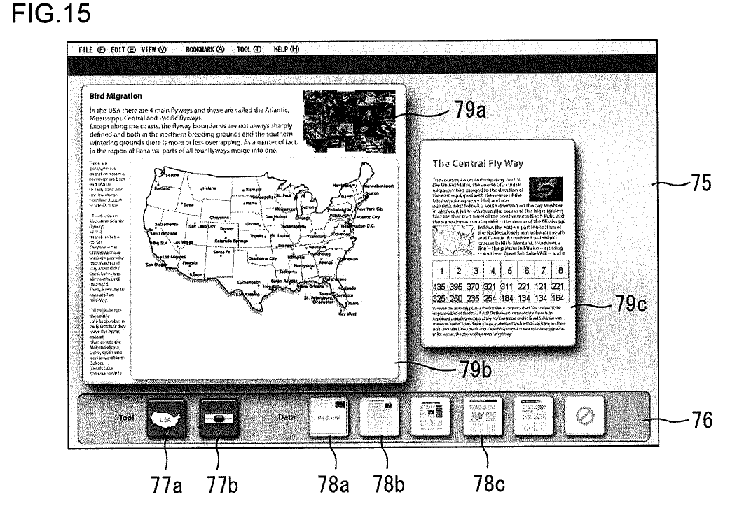

Then, upon moving the icon that represents the document 78b, which describes migratory bird route information, to the empty region in the data operation sheet 75 by operating a drag-and-drop operation, the display screen goes to the state as shown in FIG. 15. The linkage control unit 71 detects that the document data has been dropped on the data operation sheet 75, and instructs the layout control unit 73 to allocate the display region for the document 78b. Furthermore, the linkage control unit 71 starts up a processing system which displays the document 78b, thereby displaying the document 78b. Then, the display region 79c is allocated for the document 78b by the layout control unit 73, and the document 78b is displayed in the display region 79c by an appropriate processing system. In this example, the document 78b stores the longitude data and the latitude data that indicate the positions of migratory birds in increments of months. A definition file associated with the document 78b is applied, thereby displaying the migratory bird route information described in the document 78b in the form of a table.

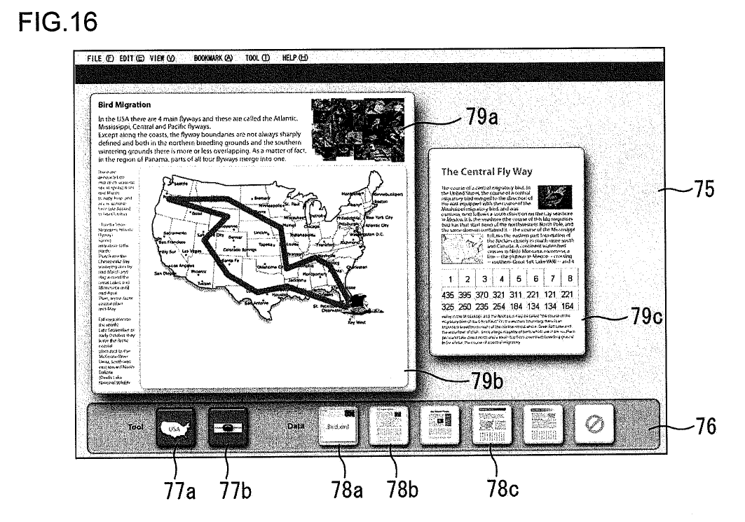

Then, upon the user moving the display region 79c that is displaying the migratory bird route information to the display region 79b of the blank map by performing a drag-and-drop operation, the display screen enters the state shown in FIG. 16. In this step, the linkage control unit 71 links the data with the function, thereby displaying the route data described in the document 78b on the blank map displayed in the display region 79a of the document 78a.

Now, let us say that the function component that displays the blank map has a function whereby, upon reception of a triaxial data set (which consists of the longitude-axis data, the latitude-axis data, and the month-axis data), the points identified by the longitude data and the latitude data in increments of months are interpolate so as to create a route curve, and the route curve thus created is displayed on the map. With such an arrangement, upon the user dropping the display region 79c, which displays the migratory route information, in the display region 79b on the blank map, the linkage control unit 71 acquires the information from the blank map display component with respect to the tags which can be received. Furthermore, the linkage control unit 71 extracts, from the data of the document 78b, the data set which can be associated with the three axes (the longitude axis, the latitude axis, and the month axis), and transmits the triaxial data set thus extracted to the blank map display component. Upon reception of the triaxial data set (the longitude-axis data, the latitude-axis data, and the month-axis data), the blank map display component displays the route on the map based upon the triaxial data set thus received. Thus, the migratory bird route is displayed on the map. With an arrangement in which the blank map display component is realized by the VC unit 80 executing a definition file, a definition file may be applied for mapping the route data described in the document 78b to SVG so that the figure in which the longitude data and the latitude data described in the document 78b are interpolated with straight lines can be displayed. This definition file may be included in the definition file associated with the document 78a.

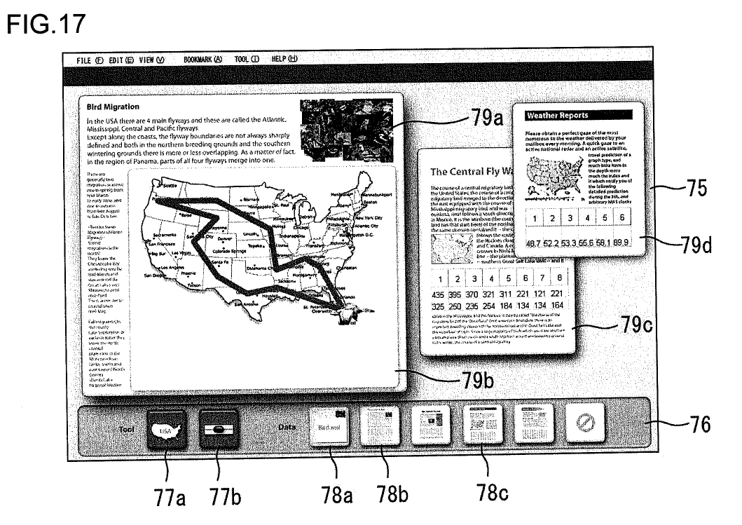

Upon the user moving the icon that represents the document 78c, which describes the temperature information in the USA, to the empty region of the data operation sheet 75 by performing a drag-and-drop operation, the display screen enters the state shown in FIG. 17. The linkage control unit 71 detects that the document data has been dropped on the data operation sheet 75, and instructs the layout control unit 73 to allocate the display region for the document 78c. Furthermore, the linkage control unit 71 starts up a processing system which displays the document 78c, thereby displaying the document 78c. As described above, the display region 79d is allocated for the document 78c by the layout control unit 73, and the document 78c is displayed in the display region 79d by an appropriate processing system. In this example, the document 78c stores the average temperature information in increments of months for each State of the USA. A definition file associated with the document 78c is applied, thereby displaying the temperature information described in the document 78c in the form of a table.

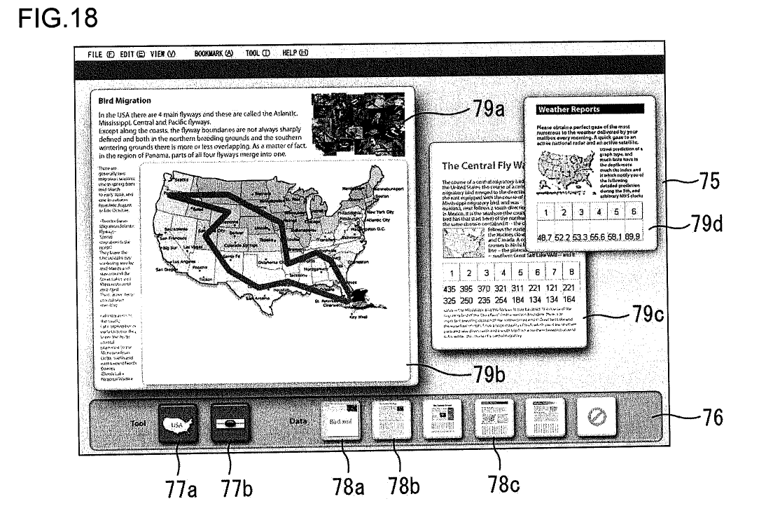

Then, upon the user moving the display region 79d that is displaying the USA temperature information to the display region 79b of the blank map by performing a drag-and-drop operation, the display screen enters the state shown in FIG. 18. In this step, the linkage control unit 71 links the data with the function, thereby displaying the temperature data described in the document 78c on the blank map displayed in the display region 79a of the document 78a.

Now, let us say that the function component that displays the blank map has a function whereby, upon reception of triaxial data set (which consists of the State-name-axis data, the temperature-axis data, and the month-axis data), the temperature information is displayed on the map in increments of States. With such an arrangement, upon the user dropping the display region 79d, which displays the temperature information in increments of States, in the display region 79b on the blank map, the linkage control unit 71 acquires the information from the blank map display component with respect to the tags which can be received. Furthermore, the linkage control unit 71 extracts, from the data of the document 78c, the data set which can be associated with the three axes (the State-name axis, the temperature axis, and the month axis), and transmits the triaxial data set thus extracted to the blank map display component. Upon reception of the triaxial data set (the State-name-axis data, the temperature-axis data, and the month-axis data), the blank map display component displays the temperature information in increments of States based upon the triaxial data set thus received. Let us consider an arrangement in which settings of the blank map display component have been made such that the data defined by <average temperature> tag can be handled as the “temperature” data. With such an arrangement, the linkage control unit 71 appropriately links the document 78c with the blank map display component, even if the document 78c describes the temperature data with the <average temperature> tag. Also, an arrangement may be made in which settings of the blank map display component are made so as to receive the data having the concept of “temperature” based upon the ontology. With such an arrangement, the linkage control unit 71 determines that the <average temperature> tag matches the concept of “temperature”, and appropriately links the document 78c with the blank map display component. Thus, the average temperature information is displayed on the map in increments of States. An arrangement may be made in which the blank map display component is realized by the VC unit 80 executing a definition file. With such an arrangement, a definition file may be applied for changing the color specified in the SVG data which represents the shape of each state on the blank map of the USA, thereby displaying a map of the States of the USA colored in increments of States based upon the month-average temperature information described in the document 78c.

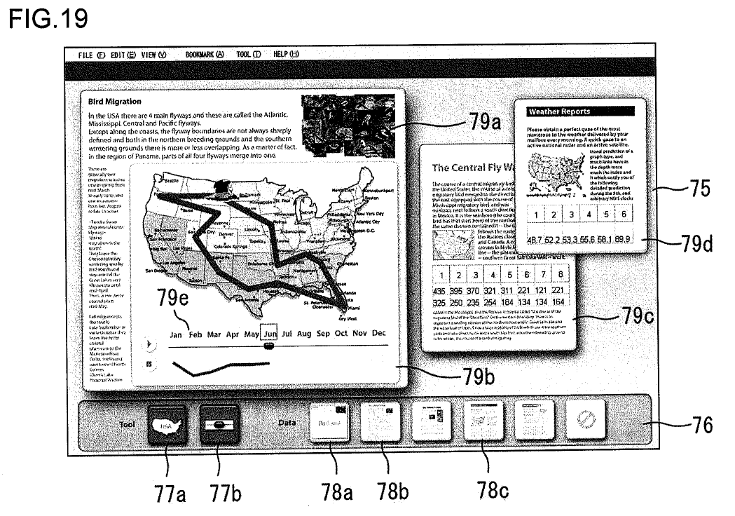

Then, upon the user moving the time-slider tool icon 77b to the display region 79a of the document 78a by performing a drag-and-drop operation, the display screen enters the state shown in FIG. 19. In this stage, the time slider control unit 74 provided by the blank map display component displays a time slider 79e.

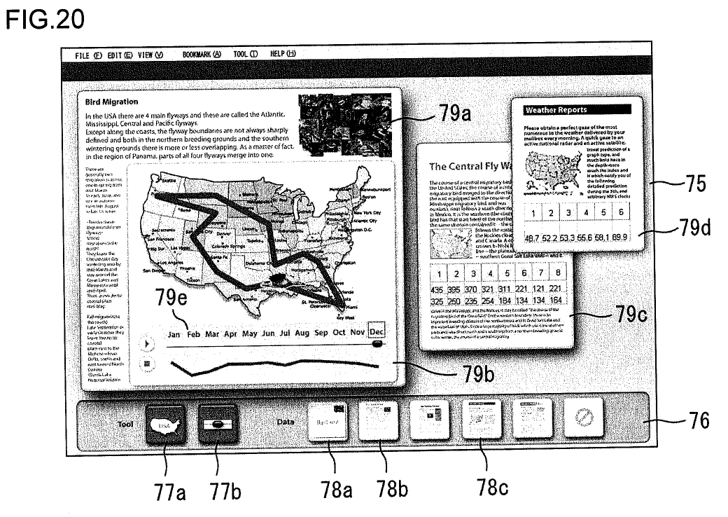

Upon the user operating the time slider, the time slider control unit 74 notifies the blank map display component of the time information so as to display the time data according to and synchronous with the position of the knob of the slider, whereupon the display screen enters the state shown in FIG. 20. In this stage, the blank map display component has received the data with respect to “month” via the linkage control unit 71. Accordingly, the blank map display component displays an image of a bird at the position through which the migratory birds pass on the month according to the notice received from the time slider control unit 74. Furthermore, the blank map display component displays the average temperature information for the target month in increments of States. FIG. 19 shows a screen on which the data for June is displayed. On the other hand, FIG. 20 shows a screen on which the data for December is displayed.

The above-described technique allows the data pieces included in multiple documents to be linked with each other in a simple manner, thereby providing a document processing environment with improved flexibility and convenience. As described in the base technology, the data in each document is retained in the form of a DOM, which allows the data stored in the document to be referred to by an external component using an API provided by the DOM unit 30. Such a data reference function allows documents to be linked with each other. Furthermore, the DOM unit 30 has a function whereby, upon modifying the DOM, a notice of this modification is issued using a mutation event. Thus, even if the data linked by the linkage control unit 71 is modified, the display of the documents is updated according to this modification.

Description has been made regarding the present invention with reference to the embodiments. The above-described embodiments have been described for exemplary purposes only, and are by no means intended to be interpreted restrictively. Rather, it can be readily conceived by those skilled in this art that various modifications may be made by making various combinations of the aforementioned components or processes, which are also encompassed in the technical scope of the present invention.

Description has been made in the above embodiments regarding an arrangement for processing an XML document. Also, the document processing apparatus 100 has a function of processing other markup languages, e.g., SGML, HTML, etc.

### INDUSTRIAL APPLICABILITY

The present invention is applicable to a document processing apparatus which processes a document structured by a markup language.

1. A document processing apparatus comprising:
an acquisition unit which acquires a document described in a markup language;
a processing system which processes data included in the document thus acquired; and
a linkage control unit which selects the data, which is to be processed by said processing system, from the data included in the document,
wherein said linkage control unit acquires the information for selecting the data which can be processed by said processing system,
and wherein said linkage control unit selects based upon the information thus acquired, the data, which is to be processed by said processing system, from the document thus acquired by said acquisition unit.

2. A document processing apparatus according to claim 1, wherein said processing system has the information for selecting the data which can be processed by said processing system,
and wherein said linkage control unit acquires the information from the processing system so as to select the data to be processed by said processing system.

3. A document processing apparatus according to claim 1, wherein the document has additional information which defines the data included in the document in a semantic manner,
and wherein said linkage control unit selects the data to be processed by said processing system with reference to the information that defines the data in a semantic manner.

4. A document processing apparatus according to claim 3, wherein the information for selecting the data which can be processed by said processing system includes the information which defines the data in a semantic manner,
and wherein said linkage control unit makes a comparison between the information that defines in a semantic manner the data which can be processed by said processing system and the information which defines in a semantic manner the data included in the document so as to extract the data in which the information matching is satisfied in a conceptual manner.

5. A document processing apparatus according to claim 4, wherein said linkage control unit calculates scores that indicate the semantic distances in increments of data pieces included in the document based upon the information that defines in a semantic manner the data which can be processed by said processing system and the information that defines in a semantic manner the data included in the document,
and wherein said linkage control unit selects the data which is to be processed by said processing system with reference to the scores.

6. A document processing apparatus according to claim 1, wherein, when said processing system processes a plurality of kinds of data pieces, said linkage control unit extracts the candidates of data pieces, which are to be processed by said processing system, from among the data pieces included in the document in increments of the plurality of kinds of data pieces,
and wherein said linkage control unit selects the data piece to be processed by said processing system from among the candidates thus extracted, based upon the degree of the structural vicinity in a hierarchical structure of the document.

7. A document processing method comprising:
acquisition of a document described in a markup language;
acquisition of information for selecting data which can be processed by a processing system which processes data described in the markup language;
selection of data, which is to be processed by said processing system, from the document thus acquired based upon the information for selecting the data; and
issuing an instruction to said processing system to process the data thus selected.

8. A computer program product comprising:
a document acquisition module which acquires a document described in a markup language;
a data processing module which processes data included in the document thus acquired; and
a data selection module which selects the data, which is to be processed by said data processing module, from the data included in the document,
wherein said data selection module acquires the information for selecting the data which can be processed by said data processing module,
and wherein said data selection module selects based upon the information thus acquired, the data, which is to be processed by said data processing module, from the document thus acquired by said data acquisition module.

9. A document processing apparatus comprising:
an acquisition unit which acquires a plurality of documents described in a markup language;
a linkage control unit which creates correspondence between data pieces included in the plurality of documents, and controls the correspondence between the data pieces; and
a display control unit which displays the plurality of documents with the data pieces linked with each other according to the correspondence thus created.

10. A document processing apparatus according to claim 9, wherein said linkage control unit creates the correspondence based upon the element names or the attribute names of the data pieces.

11. A document processing apparatus according to claim 9, wherein said display control unit acquires a definition file which defines rules for displaying the data pieces linked with each other according to the correspondence thus created, and displays the plurality of documents based upon the rules.

12. A document processing apparatus according to claim 9, further comprising a time slider control unit configured such that, in a case in which the document includes data associated with time information, a time slider is displayed, which allows the user to set the time information.

13. A document processing apparatus according to claim 12, wherein, in a case in which a plurality of documents that are being processed include data pieces associated with the time information, the data pieces are displayed synchronously with the time information received by said time slider control unit.
